(19) United States
(12) Patent Application Publication
(10) Pub. No.: US 2025/0010517 A1
(43) Pub. Date: Jan. 9, 2025

(54) PRODUCTION LINE COMBINING ON-SITE MIXING AND CONSTRUCTION FOR GREEN AND ULTRA-HIGH-PERFROMANCE CONCRETE

(71) Applicant: Dongmin ZHU, Guiyang (CN)

(72) Inventor: Dongmin ZHU, Guiyang (CN)

(21) Appl. No.: 18/346,731

(22) Filed: Jul. 3, 2023

(51) Int. Cl. B28C 9/04; B28C 9/00

(52) U.S. Cl. CPC B28C 9/049; B28C 9/002

(57) ABSTRACT

A production line combining on-site mixing and construction for a green and ultra-high-performance concrete includes a concrete manufacturing area and raw material stacking area located directly at a construction site. A mixing equipment is provided on the concrete manufacturing area. A concrete discharge end of the mixing equipment is connected to a construction pouring area through a concrete conveying device. A plurality of quantitative material packs and a transfer mechanism are provided in the raw material stacking area. The transfer mechanism is configured for both the stacking of the plurality of quantitative material packs and the transfer of at least one package per time to the mixing equipment. The production line features a straightforward overall structure, convenient operation, cost-effective equipment investment, minimal space occupancy, and enables integrated on-site manufacturing and pouring of concrete.

### FIELD OF THE INVENTION

The present invention relates to the field of concrete production, and especially to a production line combining on-site mixing and construction for a green and ultra-high-performance concrete.

### BACKGROUND OF THE INVENTION

Concrete is the most widely used construction material and structural engineering material in various human engineering projects. However, existing concrete commonly suffers from issues such as poor durability, significant structural cracking, and insufficient strength.

Currently, there is a widespread issue of “bulky beams, stout columns, and thick piers” in the construction of concrete components, leading to significant waste of resources. Additionally, concrete structures in buildings often suffer from severe cracking, reaching a point where it is commonly said that “no house, bridge, or dam is free from cracks,” which poses a serious threat to the quality and safety of constructions. Moreover, the current practice of pumping precast concrete, in order to address the workability issues within the first two hours, involves the excessive use of various additives. This approach, while attempting to ensure short-term workability, brings hidden defects and risks to the long-term stability and quality of the buildings, thereby severely hindering the sustainable development of concrete.

In conclusion, the current concrete production and pumping processes fail to meet the durability requirements of concrete, as well as the high-quality development and green, low-carbon principles of the construction industry. They fall far short of the national goal of achieving “century-long projects and millennium-long plans” in terms of design requirements. There is an urgent need for technological innovation to develop advanced and environmentally-friendly manufacturing and construction techniques for concrete that offer higher strength and longer lifespan. This will drive the fifth technological revolution in the concrete industry and contribute to the overall goal of achieving sustainable and high-quality development.

An analysis of the reasons behind the current issues with concrete is as follows:

### 1) The Construction Technique of Ready-Mixed Concrete Pumping

Influenced by environmental policies and the increased demand for concrete performance and quantity, the traditional on-site simple mixing approach has been replaced by the advanced technology of ready-mixed concrete pumping. Ready-mixed concrete mixing plants have effectively addressed the environmental and measurement precision issues associated with traditional on-site mixing, thus becoming the primary construction method for concrete nowadays. However, ready-mixed concrete mixing plants are typically constructed in remote outskirts, while urban constructions are situated in city centers. Consequently, after production at the suburban mixing plants, concrete is transported to the construction sites within a 2-hour timeframe using concrete mixing trucks and then pumped to high-rise structures using concrete pump trucks. It is precisely due to this two-hour transportation distance that modern concrete quality encounters new challenges:

(1) Decreased durability of concrete. In order to ensure that concrete is transported to the construction site within 2 hours while maintaining its workability, concrete producers heavily rely on the incorporation of admixtures to extend the concrete's setting time. However, this practice introduces latent defects and hazards, compromising the long-term quality stability of the buildings and sacrificing the longevity of the concrete itself, consequently increasing the production costs of concrete.

(2) Increased transportation costs of concrete. The round-trip transportation costs of concrete mixing trucks are significant. Each time a truck transports concrete, it needs to be thoroughly cleaned, resulting in a tremendous consumption of water resources. Furthermore, almost 5% of the concrete remains unemptied during the discharge process, leading to substantial waste in large-scale pouring sites. Moreover, this process contributes to additional energy consumption and pollution.

### 2) Non-Uniform Concrete Mixture Affecting Strength and Service Life

Concrete, comprising primarily of aggregates (sand and gravel), various powders, water, and different admixtures, is mixed to achieve the desired strength or grade. Traditional methods rely on extending the mixing time to enhance the homogeneity of concrete components. Mechanical mixing, predominantly used in traditional mixing equipment, employs low-speed rotation of mechanical blades to induce convection, vortices, and shear forces among the materials, ensuring thorough blending. However, when it comes to incorporating fine powders, including ultra-fine particles at the nanoscale, mechanical mixing devices encounter a size disparity between the machinery and the aggregates and powders. Consequently, they fail to address the fundamental challenge of powder homogenization. At a microscopic level, powders retain localized individual components, impeding complete chemical reactions and resulting in hidden cracks within the concrete. As a consequence, the concrete's strength potential remains underutilized. Moreover, the non-uniformity in composition contributes to uneven strength distribution in concrete elements, necessitating an increase in the concrete strength coefficient for assurance. This phenomenon leads to the emergence of “bulky beams, stout columns, and thick piers,” resulting in the wastage of substantial non-renewable resources.

### 3) Instability in the Gradation of Sand and Gravel Aggregates

Mechanically crushed sand and gravel aggregates constitute the primary components of concrete, accounting for over 75-85% of its composition. The quality of these aggregates plays a crucial role in determining concrete's overall quality. These aggregates exhibit significant variations in particle size, ranging from millimeters to micrometers. During the storage and transportation of sand and gravel aggregates, inevitable phenomena of segregation occur. Segregation leads to the accumulation of finer particles in the central region while coarser aggregates settle towards the periphery. In the process of material extraction, it is common practice to take materials from the outer regions towards the inner regions. Consequently, the initial batches of mixing utilize coarser aggregates, while subsequent batches employ finer aggregates. This severe inconsistency greatly impacts the quality of the concrete. As a result, each batch of mechanically crushed sand and gravel aggregates possesses a unique gradation, rendering it impossible to achieve precise control over the raw materials in concrete production, thus undermining the accurate measurement capabilities of the mixing plant.

### (4) Disconnection Between Sand and Gravel Aggregate Production and Concrete Material Flow Management

There exists a lack of synchronization between the production of sand and gravel aggregates and the material flow management in concrete production, which to some extent compromises the quality of concrete raw materials. Sand and gravel aggregate production companies focus on controlling the production quality of these aggregates, while concrete mixing plants prioritize measurement accuracy. Unfortunately, the intermediate processes of storage, transportation, and handling lack necessary quality control measures. This disjointed approach contributes to the deterioration of concrete quality, serving as one of the reasons for its inferior performance.

As society continues to advance, there is an increasing demand in the market for high-quality concrete. Therefore, the development of a production line for green (ultra) high-performance concrete, encompassing both on-site mixing and construction, is an urgent technological challenge that needs to be addressed.

### SUMMARY OF THE INVENTION

Given these circumstances, the objective of this invention is to provide a production line for green (ultra) high-performance concrete, which combines on-site mixing and construction, thereby overcoming the shortcomings of existing technologies.

A production line combining on-site mixing and construction for a green and ultra-high-performance concrete includes a concrete manufacturing area and raw material stacking area located directly at a construction site. A mixing equipment is provided on the concrete manufacturing area. A concrete discharge end of the mixing equipment is connected to a construction pouring area through a concrete conveying device. A plurality of quantitative material packs and a transfer mechanism are provided in the raw material stacking are. The transfer mechanism is configured for both the stacking of the plurality of quantitative material packs and the transfer of at least one package per time to the mixing equipment.

In some embodiments, the mixing equipment is designed with a modular structure, and includes a concrete mixing machine positioned on a lower level, a powder mixing machine and a storage silo parallelly arranged on an intermediate level, and a dispensing mechanism on an upper level for the automatic dispensing of the plurality of quantitatively packaged material packs. The powder mixing machine is connected to a metering water supply system and a metering admixture feeding system. A discharge outlet of the concrete mixing machine is connected to a sewage treatment system via a drain pipe, while a clean water discharge outlet of the sewage treatment system is cyclically connected to the metering water supply system.

In some embodiments, the plurality of quantitative material packs include an aggregate pack and a powder pack; the aggregate pack is connected to the concrete mixer through the storage silo. The powder pack is connected to the powder mixing machine. A discharge end of the powder mixing machine is connected to the concrete mixing machine.

In some embodiments, the plurality of quantitative material packs include a standardized container, and a waterproof bag or a sealed container; measured quantities of aggregates or powdered mixtures are provided within the waterproof bag or the sealed container, following a predetermined concrete formulation and a required volume based on a specification of a mixing station model.

In some embodiments, the powder mixing machine is a high-speed planetary powder mixer, an ultrasonic powder mixer, or a high-frequency and high-vibration mixer.

In some embodiments, the concrete conveying device is a concrete pump-belt conveyor, a bucket-hoist mechanism, or an automotive conveying mechanism.

In some embodiment, the concrete discharge end of the mixing equipment is connected to a storage hopper. The storage hopper is seamlessly attached to the conveying device, allowing the concrete on the storage hopper being conveyed to the construction pouring area.

In some embodiments, the transfer mechanism is an automatic loading and unloading mechanism. The automatic loading and unloading mechanism includes a stacker robot, a crane, a stacker, and a conveyor belt or an automotive mechanical device.

In some embodiments, a plurality of material conveying device for conveying the plurality of quantitative material packs are provided in the raw material stacking area; the material conveying device comprises an aggregate pack conveyor, a powder pack conveyor, and a recycling conveyor.

The advantages of the present invention is as follows.

(1) The present invention is designed to be located directly at the construction site, featuring a simple overall structure and convenient operation. This innovative system offers the advantages of low equipment investment costs. Moreover, the produced mixture can be promptly pumped and poured without any slump loss or wastage, eliminating the need for excessive addition of admixtures to maintain its fluidity. This on-site preparation and casting of concrete ensure excellent concrete performance while minimizing production costs.

(2) The mixing equipment is designed in a tower station structure, occupying minimal space and avoiding interference with other activities at the casting site. It is equipped with two mixers for segmented mixing. The powders, admixtures, and water are initially mixed using a high-speed planetary powder mixer, and then they enter the concrete mixer for blending with the aggregate. This arrangement ensures a uniform mixture of the components, thereby further enhancing the quality of the concrete.

(3) The sand and aggregate are processed into predetermined quantities of material packs according to the required grading specifications. The concrete preparation is carried out using at least one pack per batch, ensuring that the material packs maintain their optimal proportions from the earlier production stage at the sand and aggregate production site. This approach eliminates the segregation phenomenon and results in concrete with high compressive strength and crack resistance. The material packs are stacked in the stacking area using a stacking method, facilitating their management and transportation. An automatic loading and unloading mechanism is employed for rapid stacking, placement, and retrieval of the material packs. The material packs are pre-measured with the required material proportions, eliminating the need for an additional material measurement system at the mixing station. This significantly reduces equipment costs and maintenance expenses. Additionally, it enables fast material discharge and mixing, leading to high production efficiency and excellent product quality.

(4) The entire system, from raw material preparation, transportation, concrete preparation, to pouring, functions seamlessly during the concrete production process. It incorporates modular packaging, modular transportation, centralized stacking, and continuous material discharge. This system eliminates the need for loose material storage, handling, and separate material measurement during the mixing process. As a result, it achieves high handling efficiency, low transportation costs, and minimizes the risk of leakage and dust generation during transportation. Moreover, the mixing station can directly utilize the material packs, resulting in minimal dust emissions and promoting a green and environmentally friendly approach.

The additional advantages, objectives, and features of the present invention will be elaborated upon in the subsequent specification. To a certain extent, based on a thorough examination of the following discourse, these advantages and objectives will become apparent to those skilled in the art or can be derived from the practical implementation of the invention. The goals and further advantages of the present invention can be achieved and obtained through the following detailed description.

### BRIEF DESCRIPTION OF THE DRAWINGS

To elucidate the objectives, technical solutions, and advantages of the present invention more clearly, a detailed description will be provided below in conjunction with the accompanying drawings.

FIG. 1 is a flow schematic diagram of the production line according to embodiment 1 of the present invention.

FIG. 2 is a flow schematic diagram of the production line according to embodiment 2 of the present invention.

FIG. 3 is a flow schematic diagram of the production line according to embodiment 3 of the present invention.

FIG. 4 is a flow schematic diagram of the production line according to embodiment 4 of the present invention.

FIG. 5 is a first enlarged schematic diagram of the mixing equipment.

FIG. 6 is a second enlarged schematic diagram of the mixing equipment.

FIG. 7 is a third enlarged schematic diagram of the mixing equipment.

### DETAILED DESCRIPTION OF THE INVENTION

The following detailed description will refer to the accompanying drawings and present the preferred embodiments of the present invention. It should be understood that these embodiments are provided for illustrative purposes only and do not limit the scope of the invention.

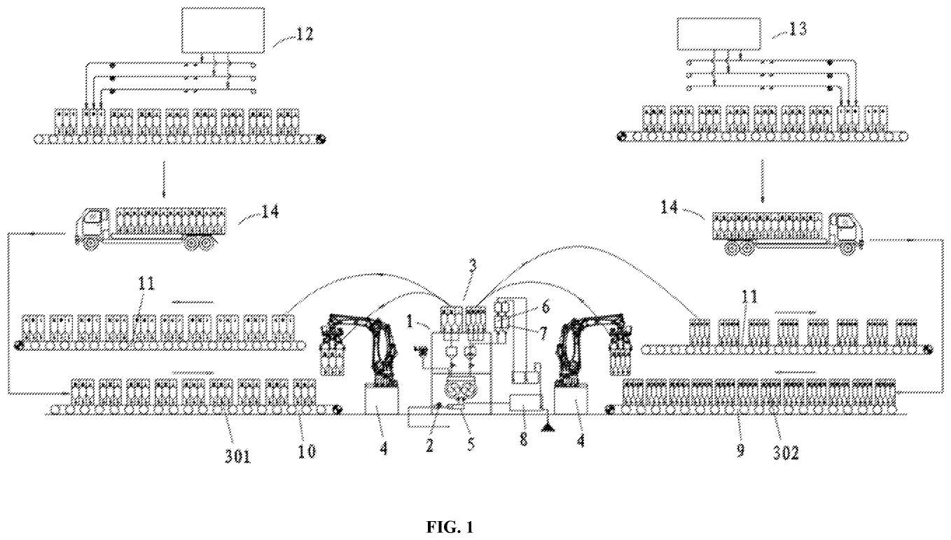

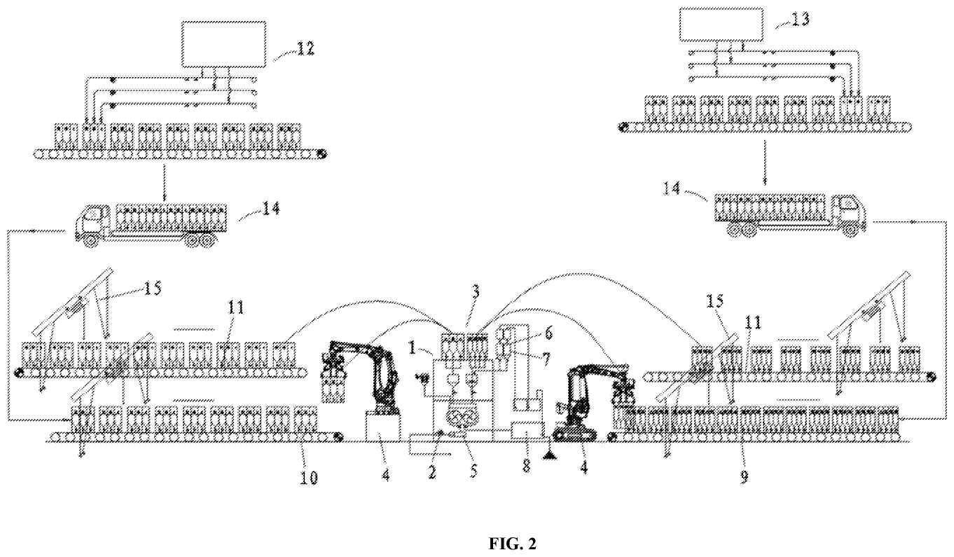

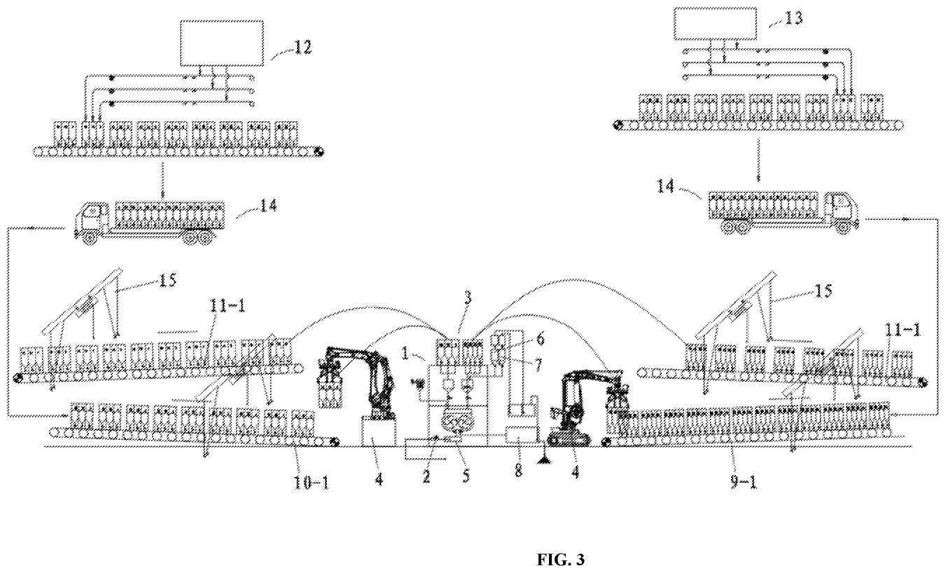

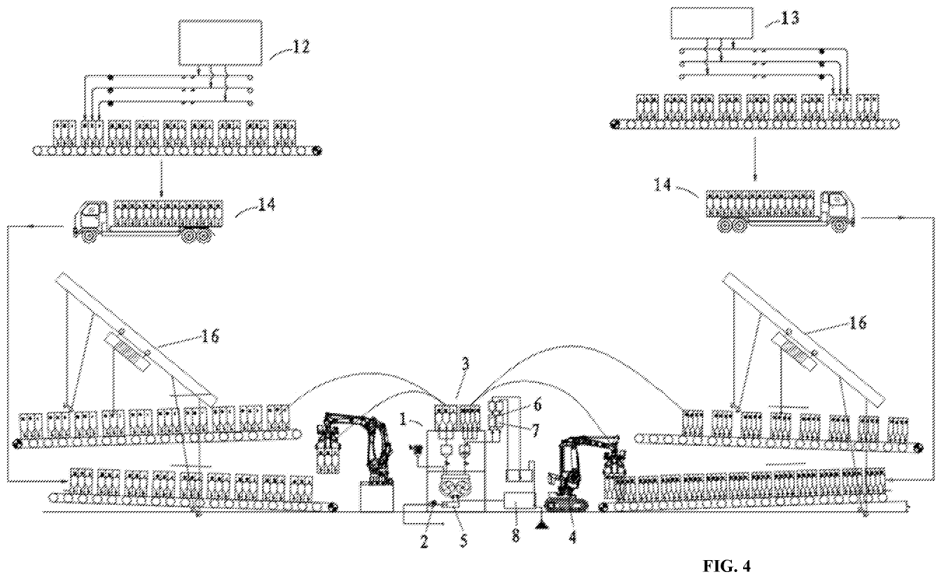

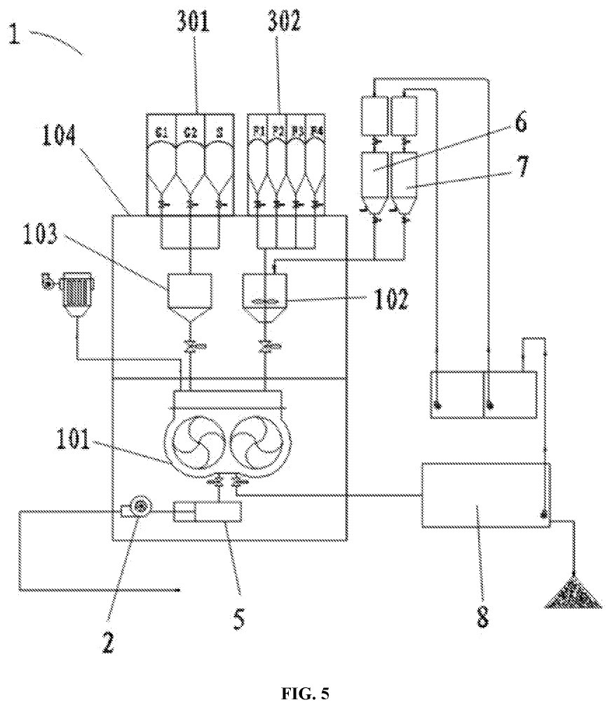

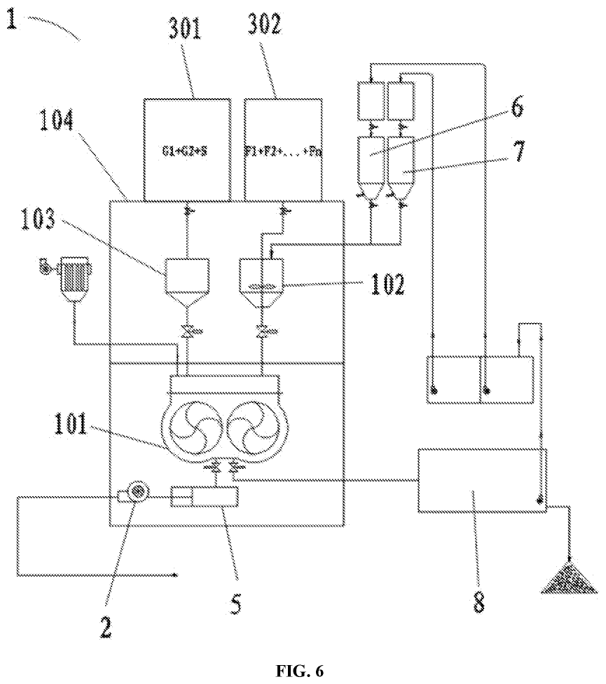

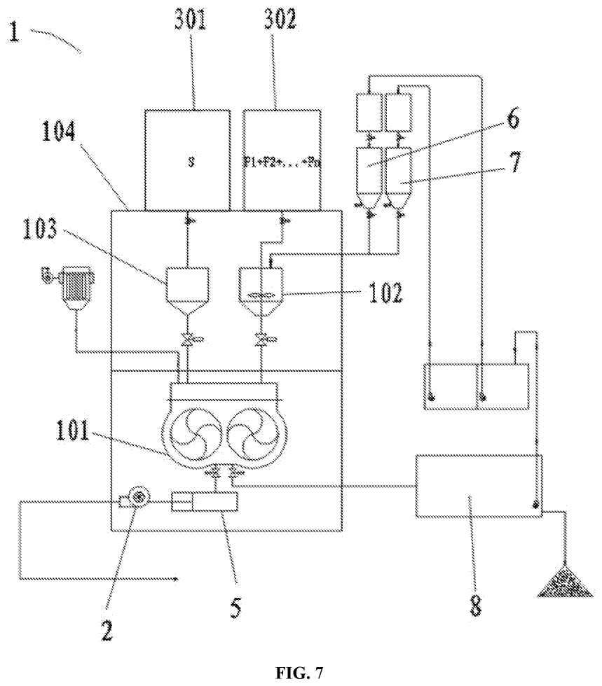

Referring to FIGS. 1 to 7, the present invention discloses a production line combining on-site mixing and construction for green (ultra) high-performance concrete. The production line includes a concrete manufacturing area and a stacking area. In the concrete manufacturing area, a mixing equipment 1 is provided, and a concrete conveying device 2 is arranged at a discharge end of the mixing equipment 1. In the stacking area, a plurality of stacked and placed quantitative material packs 3 and a transfer mechanism 4 are provided. Each quantitative material pack 3 includes a mixture of sand, aggregates, and either one or a combination of powders, prepared according to the specified grading requirements. The transfer mechanism 4 is used for stacking the quantitative material packs 3 and delivering at least one package at a time into the mixing equipment 1.

The concrete manufacturing area and the stacking area are situated on the construction site. The discharge end of the mixing equipment 1 is connected to a construction pouring area via the concrete conveying mechanism 2.

At the discharge end of mixing equipment 1, there is a storage hopper 5. The storage hopper 5 seamlessly connects to the concrete conveying mechanism 2, allowing for the transportation of the prepared concrete to the construction pouring area. This facilitates the direct conveyance of the produced concrete to the construction site for building purposes.

The storage hopper 5 is designed with a capacity specification that enables it to store at least one batch of concrete.

The concrete conveying mechanism 2 can be implemented as a concrete pumping system, a belt conveyor, a bucket elevator, or any other type of automated conveying mechanism.

The concrete pumping system includes a conveying pipeline with a conveying pump installed on it. One end of the conveying pipeline is connected to the discharge outlet of the mixing machine, while the other end is connected to the pouring site or the respective receiving device.

The belt conveyor is a metering belt conveyor.

The mixing equipment 1 is a multi-level structure including a concrete mixing machine 101 located on the lower level, a powder mixing machine 102 and a storage silo 103 positioned in parallel on the middle level, and a dispensing mechanism 104 on the upper level for automatic dispensing of the quantitative material packs 3. The powder mixing machine 102 is also connected to the metering water supply system 6 and the metering admixture feeding system 7. The discharge outlet of the concrete mixing machine 101 is connected to a wastewater treatment system 8 through a drainage pipe, and the clean water discharge outlet of the wastewater treatment system 8 is cyclically connected to the metering water supply system 6.

The quantitative material pack 3 includes an aggregate pack 301 and a powder pack 302. The aggregate pack 301 is connected to the concrete mixing machine 101 through the storage silo 103, while the powder pack 302 is connected to the powder mixing machine 102. The discharge end of the powder mixing machine 102 is connected to the concrete mixing machine 101.

The quantitative material pack 3 includes standardized containers or waterproof bags, which contain aggregates and powders precisely measured and produced according to a predetermined concrete formula and a required quantity for the mixing station model. The aggregates and powders are modularly packaged in the containers or waterproof bags, allowing for the preparation of concrete in at least one package per batch. Specifically, each container or waterproof bag contains multiple compartments separated by partitions, where different aggregates and powders of various specifications are placed. Alternatively, each container or waterproof bag may have a single compartment where aggregate mixtures or cementitious powder mixtures for mortar preparation can be placed.

Preferably, the powder mixing machine 102 can be a high-speed planetary powder mixer, an ultrasonic powder mixer, or any other high-frequency and high-vibration mixing equipment. The mixing unit of the powder mixing machine can be equipped with double helical blades, dual horizontal shaft plows, or a vertical axis planetary mixing machine.

Preferably, the dispensing mechanism 104 can be an automatic unpacking and feeding machine.

The metering water supply system 6 includes a fresh water storage tank connected to a fresh water buffer hopper and a water measuring hopper. The water measuring hopper is connected to an inlet of the powder mixing machine 102 via a water supply pipe. The water measuring hopper is equipped with graduations or a weighing scale to accurately measure the water quantity.

The metering admixture feeding system 7 includes an admixture storage tank connected to an admixture buffer hopper and an admixture measuring hopper. The admixture measuring hopper is connected to an admixture inlet of the powder mixing machine 102 via a feeding pipe. The admixture measuring hopper is equipped with graduations or a weighing scale to accurately measure the admixture quantity.

The transfer mechanism 4 is an automated loading and unloading device, which can be a stacking robot, crane, palletizer, conveyor belt, or any other type of automated mechanical device.

Multiple quantitative material pack conveying devices are provided in the stacking area, including aggregate pack conveyor 9, the powder pack conveyor 10, and recovery conveyor 11, for collecting the containers or waterproof bags.

The quantitative material pack conveying devices can be conveyor belt systems in operation.

Alternatively, the quantitative material pack conveying devices can be inclined, self-propelled transmission rollers. Specifically, the aggregate pack conveyor 9, the powder pack conveyor 10, and the recovery c conveyor 11 correspond to the first self-propelled transmission roller 9-1, the second self-propelled transmission roller 10-1, and the third self-propelled transmission roller 11-1, respectively. The first self-propelled transmission roller 9-1 and the second self-propelled transmission roller 10-1 are inclined downward in the direction closer to the mixing equipment 1, while the third self-propelled transmission roller 11-1 is inclined downward in the direction away from the mixing equipment 1. This arrangement allows for the self-gravity conveyance and recovery of the quantitative material packs, resulting in cost and energy savings. The inclination angle of the self-propelled transmission rollers is set at 2-3 degrees.

Preferably, an auxiliary hoisting mechanism is installed on one side of the quantitative material pack conveyors to further assist the operation and transportation of the quantitative material packs 3. This auxiliary hoisting mechanism enhances the convenience and stability of the operations, making them more efficient and reliable.

The auxiliary hoisting mechanism can be either a small overhead crane 15 or a gantry crane 16. These equipment options provide additional lifting and handling capabilities, ensuring efficient and safe transportation of the quantitative material packs 3 during the operations.

Specifically, a corresponding small overhead crane 15 is installed on one side of the aggregate pack conveyor 9, powder pack conveyor 10, and recovery conveyor 11 to enable independent operation and provide flexibility and convenience. Alternatively, a gantry crane 16 spanning across multiple quantitative material pack conveyors can be installed to assist in the transportation of multiple quantitative material packs 3 simultaneously. This setup allows for efficient handling and movement of the material packs during the operations.

The stacking area includes at least two sections, positioned on either side of the mixing equipment 1. Each stacking area is equipped with a minimum of two coordinated conveyor belts for efficient operation. Specifically, there are separate sections for the aggregate pack stacking area and the powder pack stacking area. The aggregate pack stacking area includes a loading conveyor belt and a corresponding recovery conveyor belt for aggregate pack transportation. Similarly, the powder pack stacking area is equipped with a loading conveyor belt and a corresponding recovery conveyor belt for powder pack transportation. A passageway is located between the two conveyor belts, allowing the flexible movement of the transfer mechanism 4. This setup enables the seamless transfer, stacking, loading, and recovery of both aggregate and powder packs simultaneously, facilitating efficient operations.

The stacking area is connected to the raw material production station through a logistics transportation system 14.

The raw material production station includes the aggregates production station 12 and the powder processing station 13. Through these stations, the aggregates and powder materials are measured and packaged in a modular manner according to the predetermined concrete formulation and batching plant specifications. This modular packaging approach addresses the issue of material segregation during the storage and transportation of concrete raw materials.

Preferably, the aggregates production station 12 is a high-quality aggregate production line, such as the “Five Double Full Dry Method Crushing Production Line for High-quality Aggregates” (referring to Chinese Patent Application No. CN 2019101516208) or the “6S Processing Production Line for Coarse and Fine Intermediate Micro Aggregates Used in Concrete” (referring to Chinese Patent Application No. CN 2020107391139). This production line produces manufactured fine aggregates, manufactured sand, and manufactured crushed stone. These materials are measured and packaged in a modular manner as aggregate packs according to the predetermined concrete formulation and batching plant specifications. The powder processing station 13 includes an integrated system consisting of the 6S processing production line for coarse and fine intermediate micro aggregates used in concrete and an existing cement production line. The stone powder processed by the 6S production line, cement processed by the cement production line, and additional powdered materials are measured and packaged in a modular manner as powder packs according to the predetermined concrete formulation and batching plant specifications.

Alternatively, the raw material production station can be an integrated aggregate and powder production system capable of simultaneously producing, measuring, and packaging both the aggregate packs 301 and the powder packs 302 in a single operation.

The foregoing description represents preferred embodiments of the present invention, but should not be construed as limiting the scope of the invention in any way. Any simple modifications, equivalent variations, or alterations made to the above embodiments based on the technical essence of the invention, which are within the scope of the technical solution of the present invention, are also encompassed by the present invention.

What is claimed is:

1. A production line combining on-site mixing and construction for a green and ultra-high-performance concrete, comprising a concrete manufacturing area and raw material stacking area located directly at a construction site; a mixing equipment (1) is provided on the concrete manufacturing area; a concrete discharge end of the mixing equipment (1) is connected to a construction pouring area through a concrete conveying device (2); a plurality of quantitative material packs and a transfer mechanism (4) are provided in the raw material stacking area; the transfer mechanism (4) is configured for both the stacking of the plurality of quantitative material packs (3) and the transfer of at least one package per time to the mixing equipment (1).

2. The production line according to claim 1, wherein the mixing equipment (1) is designed with a modular structure, and comprises a concrete mixing machine (101) positioned on a lower level, a powder mixing machine (102) and a storage silo (103) parallelly arranged on an intermediate level, and a dispensing mechanism (104) on an upper level for the automatic dispensing of the plurality of quantitatively packaged material packs (3); the powder mixing machine (102) is connected to a metering water supply system (6) and a metering admixture feeding system (7); a discharge outlet of the concrete mixing machine (101) is connected to a sewage treatment system (8) via a drain pipe, while a clean water discharge outlet of the sewage treatment system (8) is cyclically connected to the metering water supply system (6).

3. The production line according to claim 2, wherein the plurality of quantitative material packs (3) comprise an aggregate pack (301) and a powder pack (302); the aggregate pack (301) is connected to the concrete mixer (101) through the storage silo (103); the powder pack (302) is connected to the powder mixing machine (102); a discharge end of the powder mixing machine (102) is connected to the concrete mixing machine (101).

4. The production line according to claim 3, wherein the plurality of quantitative material packs (3) comprise a standardized container, and a waterproof bag or a sealed container; measured quantities of aggregates or powdered mixtures are provided within the waterproof bag or the sealed container, following a predetermined concrete formulation and a required volume based on a specification of a mixing station model.

5. The production line according to claim 2, wherein the powder mixing machine (102) is a high-speed planetary powder mixer, an ultrasonic powder mixer, or a high-frequency and high-vibration mixer.

6. The production line according to claim 1, wherein the concrete conveying device (2) is a concrete pump-belt conveyor, a bucket-hoist mechanism, or an automotive conveying mechanism.

7. The production line according to claim 6, wherein the concrete discharge end of the mixing equipment (1) is connected to a storage hopper (5); the storage hopper (5) is seamlessly attached to the conveying device (2), allowing the concrete on the storage hopper being conveyed to the construction pouring area.

8. The production line according to claim 1, wherein the transfer mechanism (4) is an automatic loading and unloading mechanism; the automatic loading and unloading mechanism comprises a stacker robot, a crane, a stacker, and a conveyor belt or an automotive mechanical device.

9. The production line according to claim 1, wherein a plurality of material conveying device for conveying the plurality of quantitative material packs are provided in the raw material stacking area; the material conveying device comprises an aggregate pack conveyor (9), a powder pack conveyor (10), and a recycling conveyor (11).
